(19) United States
(12) Patent Application Publication
(10) Pub. No.: US 2021/0087668 A1
(43) Pub. Date: Mar. 25, 2021

(54) THERMAL SPRAY NOZZLE AND PLASMA THERMAL SPRAY DEVICE

(71) Applicant: MITSUBISHI HEAVY INDUSTRIES, LTD., Tokyo (JP)

(72) Inventors: Kazuhiro YOSHIDA, Tokyo (JP); Shinji FUKAO, Tokyo (JP); Kei HIGASHI, Tokyo (JP); Shuji TANIGAWA, Tokyo (JP); Takumi BONO, Tokyo (JP)

(21) Appl. No.: 16/634,645

(22) PCT Filed: Sep. 25, 2018
(86) PCT No.: PCT/JP2018/035451

§ 371 Date: Jan. 28, 2020

(30) Foreign Application Priority Data
Sep. 28, 2017 (JP) 2017-188771

(51) Int. Cl. C23C 4/134

(52) U.S. Cl. CPC C23C 4/134

(57) ABSTRACT

A plasma thermal spray device includes a nozzle body (41) having a main flow passage (48) that has a plasma flame (37) formed therein in a direction toward a downstream side from an upstream end (41A) disposed on one side in an axis direction, and extending along an axis (Ax); a powder introduction port (43) that is provided in a portion of the nozzle body (41) located the downstream side from the upstream end (41A) and introduces thermal spray powder (36) from a radially outer side to the plasma flame (37); and a fluid introduction port (45) that is provided at a position closer to the downstream side than a formation position of the powder introduction port (43) in the nozzle body (41) and introduces a working fluid into the main flow passage (48) from the radially outer side of the nozzle body (41).

### TECHNICAL FIELD

The present invention relates to a thermal spray nozzle and a plasma thermal spray device.

Priority is claimed on Japanese Patent Application No. 2017-188771, filed Sep. 28, 2017, the content of which is incorporated herein by reference.

### BACKGROUND ART

As a conventional thermal spray device, there is a plasma thermal spray device that uses thermal spray powder.

In the plasma thermal spray device, a working gas is converted into plasma by an arc generated between an anode and a cathode, and a plasma flame is formed with the working gas converted into the plasma.

Then, a thermal spray film is formed by melting the thermal spray powder with the plasma flame and spraying the melted thermal spray powder on an object to be treated.

The plasma thermal spray device having such a configuration is used, for example, when forming a thermal barrier coating film or an antifriction coating film on a gas turbine or an aircraft engine component.

Generally, the thermal spray powder has variations in particle diameter. For this reason, if the thermal spray powder is supplied from a position above a main flow jet, there is a possibility that thermal spray powder having a smaller particle diameter (thermal spray powder having lighter weight) is repelled on the surface of the plasma flame, or thermal spray powder with a larger particle diameter (thermal spray powder with heavier weight) penetrates through the plasma flame.

If such a phenomenon occurs, only a partial thermal spray powder of the thermal spray powder put into the plasma flame cannot be heated and melted.

As a technique aiming at solving such a problem, there is, for example, PTL 1.

PTL 1 discloses a plasma thermal spray device that includes a fractional distillation part that fractionally distills a plasma within a thermal spray gun into the main flow jet and a sub flow jet, and jets thermal spray powder in a direction toward the main flow jet from a powder supply hole (powder introduction port) formed between a port of the main flow jet and a jetting port of a sub-flow jet.

### CITATION LIST

### Patent Literature

[PTL 1] Japanese Unexamined Patent Application, First Publication No. 2016-44320

### DISCLOSURE OF INVENTION

### Technical Problem

However, in PTL 1, it is difficult to sufficiently enhance the rate at which the thermal spray powder supplied from the powder introduction port is heated and melted.

Thus, an object of the invention is to provide a thermal spray nozzle and a plasma thermal spray device capable of sufficiently enhancing the rate at which thermal spray powder supplied from a powder introduction port is heated and melted.

### Solution to Problem

In order to solve the above problem, a thermal spray nozzle according to one aspect of the invention includes a nozzle body having a main flow passage that has a plasma flame formed therein in a direction toward a downstream side from an upstream end disposed on one side in an axis direction, and extending along an axis; a powder introduction port that is disposed in a portion of the nozzle body located the downstream side from of the upstream end and introduces thermal spray powder from a radially outer side of the nozzle body to the plasma flame; and a fluid introduction port that is disposed at a position closer to the downstream side than a formation position of the powder introduction port in the nozzle body or at a same position in the axis direction as the powder introduction port in the nozzle body, and introduces a working fluid into the main flow passage from the radially outer side of the nozzle body.

According to the invention, by including the fluid introduction port that is disposed a position closer to the downstream side than the formation position of the powder introduction port or at the same position in the axis direction as that of the powder introduction port and introduces the working fluid into the main flow passage from a radially outer side of the nozzle body, it is possible to maintain thermal spray powder having different particle diameters inside the plasma flame or in the vicinity of the plasma flame with the working fluid supplied from the radially outer side of the nozzle body to sufficiently heat and melt the thermal spray powder.

Accordingly, the rate at which the thermal spray powder supplied from the powder introduction port is heated and melted can be sufficiently enhanced.

Additionally, in the thermal spray nozzle according to the one aspect of the invention, an opening diameter of the fluid introduction port may be a size such that the working fluid present outside the fluid introduction port is allowed to be suctioned into the main flow passage via the fluid introduction port.

By adopting such a configuration, it is possible to maintain a thermal spray powder having different particle diameters (weights) inside the plasma flame or in the vicinity of the plasma flame by the working fluid introduced into the main flow passage to sufficiently heat and melt the thermal spray powder.

Accordingly, the rate at which the thermal spray powder supplied from the powder introduction port is heated and melted can be enhanced.

Additionally, in the thermal spray nozzle according to the one aspect of the invention, the thermal spray powder may have a particle size distribution.

In this way, in a case where the thermal spray powder has the particle size distribution and having the different particle diameters, the rate at which the thermal spray powder supplied from the powder introduction port is heated and melted can be sufficiently enhanced.

Additionally, in the thermal spray nozzle according to the one aspect of the invention, the working fluid is air, and an outer surface of the nozzle body that exposes one end of the fluid introduction port may be exposed to the air at atmospheric pressure.

By adopting such a configuration, an ejector effect can be generated without separately providing a device that introduces the working fluid into the fluid introduction port.

Additionally, in the thermal spray nozzle according to the one aspect of the invention, the fluid introduction port may be disposed at a position closer to the downstream side than the formation position of the powder introduction port, and the fluid introduction port may be disposed to be orthogonal to the main flow passage.

In this way, by providing the fluid introduction port downstream of the formation position of the powder introduction port, the shape of the fluid introduction port can be a ring shape.

Accordingly, the working fluid is allowed to be introduced into the main flow passage from the entire periphery of the main flow passage in the radial direction. Thus, not only the thermal spray powder (thermal spray powder having heavier weight) with a larger particle diameter but also the thermal spray powder (thermal spray powder having lighter weight) with a smaller particle diameter can be guided into the plasma flame.

Additionally, by disposing the fluid introduction port so as to be orthogonal to the main flow passage, the working fluid flows in a direction toward a central direction of the plasma flame. Therefore, the thermal spray powder can be maintained within the plasma flame.

Additionally, in the thermal spray nozzle according to the one aspect of the invention, the fluid introduction port may be disposed at a position closer to the downstream side than the formation position of the powder introduction port, and the fluid introduction port may be disposed to be inclined in a direction toward a downstream side of the main flow passage from the upstream end of the main flow passage.

In this way, by inclining the fluid introduction port with respect to the direction from the upstream end of the main flow passage toward the downstream end of the main flow passage, the working fluid flowing into the main flow passage via the fluid introduction port does not easily collide with the plasma flame (easily flows the outside the plasma flame). Therefore, the plasma flame can be stabilized.

Additionally, in the thermal spray nozzle according to the one aspect of the invention, the fluid introduction port may have a first introduction port part that is provided at an outer peripheral part of the nozzle body, and a second introduction port part that is provided inside an outer peripheral part of the nozzle body and communicates with the first introduction port part and the main flow passage, the first introduction port part may include a plurality of introduction holes that extend radially about the axis, and the second introduction port part may be an introduction groove having a ring shape that surrounds the main flow passage from a circumferential direction.

In this way, by adopting the ring shape that surrounds the main flow passage from the circumferential direction, and including the second introduction port that is the introduction groove that communicates with the plurality of introduction holes, it is possible to supply the ring-shaped working fluid in the direction toward the axis from a circumferential outer side of the plasma flame.

Accordingly, it is possible to maintain more thermal spray powder than that in a case where the working fluid is supplied from one direction inside the plasma flame or in the vicinity of the plasma flame to sufficiently heat and melt the thermal spray powder.

Additionally, in the thermal spray nozzle according to the one aspect of the invention, the fluid introduction port may be an introduction groove disposed at a same position in the axis direction as the powder introduction port and below the powder introduction port, and the introduction groove may guide the working fluid in a direction orthogonal to the main flow passage.

By including the introduction groove having such a configuration, the thermal spray powder (thermal spray powder having a large momentum (initial momentum) when being sprayed from the powder introduction port) having a larger particle diameter can be maintained inside the plasma flame or in the vicinity of the plasma flame and can be heated and melted.

Additionally, in the thermal spray nozzle according to the one aspect of the invention, the fluid introduction port may have an inlet opening that is disposed at an outer surface side of the nozzle body and allows the working fluid to be introduced thereinto, and an outlet opening that allows the working fluid to be delivered to the main flow passage therethrough. The introduction port may be disposed at a same position in the axial direction as the powder introduction port, and the outlet opening may be disposed at a position closer to the downstream side than a formation position of the introduction port.

In this way, by disposing the outlet opening of the fluid introduction port downstream of the formation position of the inlet opening, the working fluid delivered from the outlet opening of the fluid introduction port does not easily collide with the plasma flame (easily flows the outside the plasma flame). Therefore, the plasma flame can be stabilized.

Additionally, in the thermal spray nozzle according to the one aspect of the invention, the introduction groove may become narrower toward the axis from an outer peripheral surface of the nozzle body when viewed from the axis direction.

In this way, by including the introduction groove that becomes narrower toward the main flow passage from the outer peripheral surface of the nozzle body as seen in the axis direction, it is possible to increase the flow velocity of the working fluid that flows into the main flow passage from the introduction groove.

Accordingly, the thermal spray powder having a larger particle diameter can be maintained inside the plasma flame or in the vicinity of the plasma flame with the working fluid that flows into the main flow passage from the introduction groove, and heated and melted.

Additionally, in the thermal spray nozzle according to the one aspect of the invention, the powder introduction port may be disposed above the main flow passage and may spray the thermal spray powder to the plasma flame formed in the main flow passage from a vertical direction.

In a case where the powder introduction port having such a configuration is used, the thermal spray powder having a larger particle diameter is easily influenced by the momentum (initial momentum) when being sprayed from the powder introduction port compared with the thermal spray powder having a smaller particle diameter.

However, even in a case where the powder introduction port having such a configuration is used, the thermal spray powder having a larger particle diameter can be maintained inside the plasma flame or in the vicinity of the plasma flame and heated and melted.

Additionally, in the thermal spray nozzle according to the one aspect of the invention, an injection port that is provided the other side in the axis direction of the nozzle body, communicates with the main flow passage, and allows the melted thermal spray powder to be sprayed therethrough together with the plasma frame may be provided.

By including the injection port having such a configuration, the melted thermal spray powder can be sprayed together with the plasma flame.

Additionally, in the thermal spray nozzle according to the one aspect of the invention, an internal diameter of the injection port may increases toward the other side of the nozzle body in the axis direction from the one side of the nozzle body in the axis direction.

The ejector effect can be enhanced by adopting such a configuration.

In order to solve the above problem, a plasma thermal spray device according to one aspect of the invention includes the above thermal spray nozzle; a cathode electrode that is disposed at an upstream end side of the nozzle body and has a first flow passage communicating with the main flow passage; an anode electrode that is disposed at a position closer to the downstream side than the cathode electrode and causes discharge in the first flow passage together with the cathode electrode; and an electrode housing part that houses the cathode electrode and the anode electrode and has a second flow passage formed between the anode electrode and the electrode housing part, and communicating with the first flow passage, and a gas introduction part introducing a gas for forming a plasma flame in the second flow passage.

According to the plasma thermal spray device of the invention, by including the above thermal spray nozzle, it is possible to maintain the thermal spray powder having different particle diameters (weights) inside the plasma flame or in the vicinity of the plasma flame with the working fluid to be supplied from the radially outer side of the nozzle body to sufficiently heat and melt the thermal spray powder.

Accordingly, the rate at which the thermal spray powder supplied from the powder introduction port is heated and melted can be enhanced.

### Advantageous Effects of Invention

According to the invention, the rate at which the thermal spray powder supplied from the powder introduction port is heated and melted can be enhanced.

### BRIEF DESCRIPTION OF DRAWINGS

FIG. 1 is a sectional view illustrating a schematic configuration of a plasma thermal spray device according to a first embodiment of the invention.

FIG. 2 is a sectional view taken in the direction of line B₁-B₂ of a thermal spray nozzle illustrated in FIG. 1.

FIG. 3 is a sectional view illustrating a schematic configuration of a plasma thermal spray device according to a first modification example of the first embodiment of the invention.

FIG. 4 is a sectional view illustrating a schematic configuration of a plasma thermal spray device according to a second modification example of the first embodiment of the invention.

FIG. 5 is a sectional view illustrating a schematic configuration of a plasma thermal spray device according to a second embodiment of the invention.

FIG. 6 is a sectional view taken in the direction of line D₁-D₂ of a nozzle body illustrated in FIG. 5.

FIG. 7 is a sectional view illustrating a schematic configuration of a plasma thermal spray device according to a modification example of the second embodiment of the invention.

### BEST MODE FOR CARRYING OUT THE INVENTION

Hereinafter, embodiments to which the invention is applied will be described in detail with reference to the drawings.

### First Embodiment

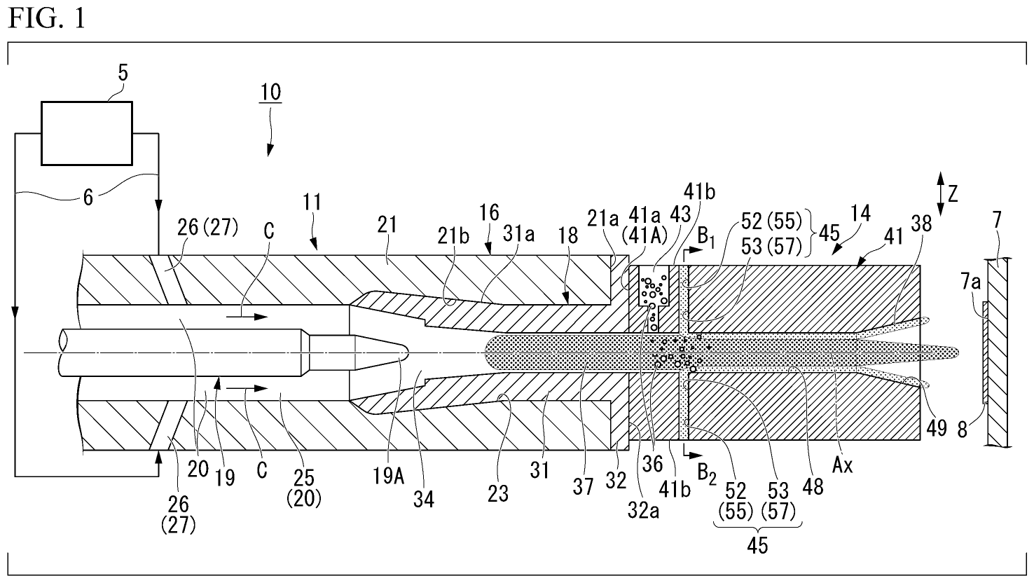

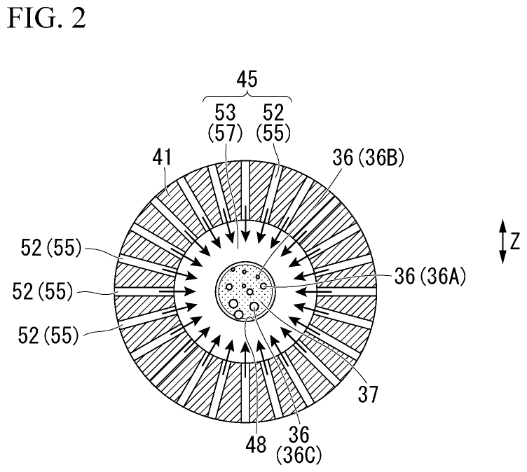

A plasma thermal spray device 10 of a first embodiment will be described with reference to FIGS. 1 and 2.

In FIG. 1, components other than a gas supply source 5, a gas supply line 6, and a cathode electrode 19 are illustrated in a section. In FIG. 1, Ax indicates an axis (hereinafter referred to as an “axis Ax”) of a plasma generation mechanism 11 and a thermal spray nozzle 14, C indicates a direction (hereinafter referred to as a “C direction”) in which a gas supplied through a gas introduction part 26 flows, and a Z direction indicates one direction of directions perpendicular to a plasma flame 37.

The plasma thermal spray device 10 has the plasma generation mechanism 11 and the thermal spray nozzle 14.

The plasma generation mechanism 11 has an electrode housing part 16, an anode electrode 18 (positive electrode), a cathode electrode 19 (negative electrode), and a second flow passage 20.

The electrode housing part 16 has an electrode housing part body 21, a cathode electrode housing part 23, an anode electrode housing part 25, and a gas introduction part 26.

The electrode housing part body 21 is a tubular member that extends in an axis direction (a direction of the axis Ax). The electrode housing part body 21 has an end surface 21a disposed on the other side in the axis direction. The end surface 21a comes into contact with a flange part 32 of the anode electrode 18. The end surface 21a faces an end surface of the thermal spray nozzle 14 disposed on one side in the axis direction via the flange part 32.

The cathode electrode housing part 23 is internally provided in a portion of the electrode housing part body 21 located on the other side in the axis direction. The cathode electrode housing part 23 is a space corresponding to an outer shape of an electrode body part 31 of the anode electrode 18 and extends in the axis direction.

An axis of the cathode electrode housing part 23 coincides with the axis Ax. A portion of the cathode electrode housing part 23 disposed on one side in the axis direction is increased in diameter toward one side in the axis direction from the other side in the axis direction.

An inner peripheral surface 21b of the electrode housing part body 21 that demarcates the cathode electrode housing part 23 comes into contact with an outer peripheral surface 31a of the electrode body part 31.

The anode electrode housing part 25 is internally provided in a portion of the electrode housing part body 21 located on one side in the axis direction. An end of the anode electrode housing part 25 on the other end side in the axis direction communicates with the cathode electrode housing part 23. The anode electrode housing part 25 is a columnar space having a larger diameter than the diameter of the cathode electrode 19 and extends in the axis direction.

An axis of the anode electrode housing part 25 coincides with the axis Ax. The anode electrode housing part 25 is a space where the cathode electrode 19 is disposed, and an outer peripheral part thereof becomes the second flow passage 20.

The gas introduction part 26 is provided so as to pass through a portion of the electrode housing part body 21 that demarcates the anode electrode housing part 25. Accordingly, one end of the gas introduction part 26 communicates with the second flow passage 20. A plurality of the gas introduction parts 26 are disposed in a circumferential direction of the electrode housing part body 21.

The other end of the gas introduction part 26 is connected to one end of the gas supply line 6. The other end of the gas supply line 6 is connected to the gas supply source 5 that supplies a gas to be converted into plasma. Accordingly, the gas is supplied to the gas introduction part 26.

As the gas introduction part 26, it is possible to use, for example, a gas introduction hole 27. The gas introduction hole 27 is disposed to be inclined with respect to the second flow passage 20 such that the gas introduced into the second flow passage 20 easily flow therethrough in the C direction. In addition, the gas introduction part 26 illustrated in FIG. 1 is an example and is not limited to this.

The anode electrode 18 has the electrode body part 31, the flange part 32, and a first flow passage 34.

The electrode body part 31 is a tubular shape and extends in the axis direction. The electrode body part 31 is housed in the cathode electrode housing part 23.

An axis of the electrode body part 31 coincides with the axis Ax. A portion of the electrode body part 31 constituting one side in the axis direction is increased in diameter toward one side of the electrode housing part 16 in the axis direction from the other side thereof in the axis direction.

The flange part 32 is provided on the other side of the electrode body part 31 in the axis direction. The flange part 32 is a portion that spreads in a radial direction from an end part of the electrode body part 31 on the other side in the axis direction. The flange part 32 is disposed between the end surface 21a of the electrode housing part body 21 and the thermal spray nozzle 14.

The first flow passage 34 is formed to pass through the electrode body part 31 and the flange part 32 in the axis direction. An axis of the first flow passage 34 coincides with the axis Ax.

An end of the first flow passage 34 on the other side in the axis direction communicates with a main flow passage 48 of the thermal spray nozzle 14. The first flow passage 34 is increased in diameter such that one side in the axis direction corresponds to an outer shape of the electrode body part 31.

The cathode electrode 19 is an electrode that extends in the axis direction. The cathode electrode 19 is housed within the anode electrode housing part 25 such that the axis thereof coincides with the axis Ax.

A distal end 19A of the cathode electrode 19 is disposed on one side of the first flow passage 34 in the axis direction. Discharge is formed between the distal end 19A of the cathode electrode 19 and the anode electrode 18.

Due to this discharge, the gas is converted into plasma and the high-temperature plasma flame 37 is formed.

The second flow passage 20 is formed between the cathode electrode 19 and the electrode housing part body 21 that demarcates the anode electrode housing part 25. An end part of the second flow passage 20 on the other side in the axis direction communicates with an end part of the first flow passage 34 on one side in the axis direction. The second flow passage 20 guides the gas, which has been supplied through the gas introduction part 26, in the C direction.

The above-described plasma generation mechanism 11 is constituted of, for example, a metallic material. The plasma generation mechanism 11 may be cooled with, for example, cooling water.

The thermal spray nozzle 14 has a nozzle body 41, a powder introduction port 43, and a fluid introduction port 45.

The nozzle body 41 is a tubular member and extends along the axis Ax. A surface 41a of the nozzle body 41 disposed on one side in the axis direction comes into contact with a surface 32a of the flange part 32 exposed from the electrode housing part body 21. The surface 41a is an upstream end 41A disposed on one side in the axis direction. An axis of the nozzle body 41 coincides with the axis Ax.

The thermal spray nozzle 14 has the main flow passage 48 and an injection port 49.

The main flow passage 48 is provided in the nozzle body 41 located between the flange part 32 and the injection port 49. The main flow passage 48 extends along the axis Ax. An axis of the main flow passage 48 coincides with the axis Ax.

The plasma flame 37 having an elongated shape in a direction toward a downstream side from the upstream end 41A disposed on one side in the axis direction as a low-temperature fluid 38 acts on the plasma flame 37 is formed in the main flow passage 48.

By forming the plasma flame 37 having such a shape, it is possible to heat thermal spray powder 36 sprayed from the powder introduction port 43 for a long time. Thus, the thermal spray powder 36 can be sufficiently melted.

The injection port 49 is internally provided on the other side of the nozzle body 41 in the axis direction. An axis of the injection port 49 coincides with the axis Ax.

One side of the injection port 49 in the axis direction communicates with the main flow passage 48. The injection port 49 allows the melted thermal spray powder 36 to be sprayed therethrough toward the outside (specifically, a film formation surface 7a of an object 7 to be treated) of the thermal spray nozzle 14.

The internal diameter of the injection port 49 is configured to increase toward the other side thereof in the axis direction from one side of the nozzle body 41 in the axis direction. An ejector effect can be enhanced by having the injection port 49 having such a shape.

The powder introduction port 43 is provided in a portion of the nozzle body 41 located downstream of the upstream end 41A. The powder introduction port 43 is disposed so as to pass through the nozzle body 41 located above the main flow passage 48.

The powder introduction port 43 allows the thermal spray powder 36 (the thermal spray powder 36 having different particle diameters (particle size distribution)) to be sprayed therethrough to the plasma flame 37 formed in the main flow passage 48 from a vertical direction (Z direction).

The thermal spray powder 36 sprayed from the powder introduction port 43 is carried to a downstream side of the main flow passage 48 while being heated and melted.

The thermal spray powder 36 having various sizes is included in the thermal spray powder 36. Specifically, thermal spray powder (hereinafter referred to as “thermal spray powder 36A”) having a particle diameter (weight) at which the powder is easily maintained within the plasma flame 37, thermal spray powder (hereinafter referred to as “thermal spray powder 36B”) that has a smaller particle diameter (lighter weight) than the thermal spray powder 36A and is easily repelled on the surface of the plasma flame 37, and thermal spray powder that has a larger particle diameter (heavier weight than the thermal spray powder 36A and easily penetrate through the plasma flame 37 in the direction from the top to the bottom (hereinafter referred to as “thermal spray powder 36C”).

The fluid introduction port 45 is provided in the nozzle body 41 at a position downstream of the formation position of the powder introduction port 43. The fluid introduction port 45 has a first introduction port part 52 and a second introduction port part 53.

The first introduction port part 52 is provided at an outer peripheral part of the nozzle body 41. The first introduction port part 52 is constituted of a plurality of introduction holes 55 disposed so as to extend radially about the axis Ax.

One end (one end of the first introduction port part 52) of each of the plurality of introduction holes 55 is exposed from an outer surface 41b of the nozzle body 41. The other end of each of the plurality of introduction holes 55 communicates with the second introduction port part 53.

The second introduction port part 53 is a ring-shaped introduction groove 57 that surrounds the main flow passage 48 from the circumferential direction.

The introduction groove 57 communicates with the main flow passage 48. In this way, by forming the shape of the introduction groove 57 as the ring shape, a working fluid is allowed to be introduced into the main flow passage 48 from the entire periphery of the main flow passage 48 in the radial direction. Thus, not only the thermal spray powder 36C (thermal spray powder having heavier weight) with a larger particle diameter but also the thermal spray powder 36B (thermal spray powder having lighter weight) with a smaller particle diameter can be guided into the plasma flame 37.

The opening diameters (the opening diameter of the fluid introduction port 45) of the plurality of introduction holes 55 and the introduction groove 57 may have, for example, a size such that the fluid present outside the fluid introduction port 45 can be suctioned into the main flow passage 48 via the fluid introduction port 45 due to the ejector effect.

Here, the principle that the ejector effect occurs will be generated.

The ejector effect means a phenomenon in which the dynamic pressure increases due to acceleration caused by a plasma jet 37b, a pressure P2 within the main flow passage 48 drops more than the pressure P1 outside the nozzle body 41, and the working fluid (for example, gas (specifically, for example, air)) present outside the nozzle body 41 flows into the main flow passage 48 due to a difference between these two pressures.

By adopting such a configuration, the working fluid introduced into the main flow passage 48 becomes the low-temperature fluid 38 that flows outside the main flow passage 48. Due to the low-temperature fluid 38, it is possible to maintain the thermal spray powder 36A to 36C having different particle diameters (weights) inside the plasma flame 37 or in the vicinity of the plasma flame 37 to sufficiently heat and melt the thermal spray powder. Thus, the rates at which the thermal spray powder 36A to 36C supplied from the powder introduction port 43 is heated and melted can be enhanced.

Additionally, as the low-temperature fluid 38 flows outside the main flow passage 48, the nozzle body 41 of which the temperature rises due to the plasma flame 37 can be cooled.

Additionally, as the low-temperature fluid 38 flows outside the main flow passage 48, a rise in the temperature of the nozzle body 41 due to the plasma flame 37 can be alleviated.

As the working fluid to be suctioned from the fluid introduction port 45, it is possible to use, for example, gas. As the gas, it is possible to use, for example, air, inert gas, or the like.

In a case where the fluid is air, an outer surface of the nozzle body 41, which exposes one end (one end of the fluid introduction port 45) of each of the plurality of introduction holes 55, may be exposed to, for example, air at atmospheric pressure. In this way, by exposing the outer surface of the nozzle body 41, which exposes the one end (one end of the fluid introduction port 45) of each of the plurality of introduction holes 55, to air at atmospheric pressure, the ejector effect can be generated without separately providing a device that introduces the fluid into the fluid introduction port 45.

The plasma thermal spray device 10 having the above configuration converts the fluid flowing through the second flow passage 20 into plasma due to the discharge formed between the anode electrode 18 and the cathode electrode 19 and forms the plasma flame 37 with the fluid converted into the plasma.

Then, by disposing the thermal spray powder 36A to 36C supplied to the plasma flame 37 inside the plasma flame 37 or in the vicinity of the plasma flame 37 with the fluid introduced into the main flow passage 48 and spraying the melted thermal spray powder 36A to 36C on the film formation surface 7a of the object 7 to be treated together with the plasma flame 37, a thermal spray film 8 is formed.

According to the thermal spray nozzle 14 of the first embodiment, by including the fluid introduction port 45 that is provided downstream of the formation position of the powder introduction port 43 and introduces the fluid into the main flow passage 48 from a radially outer side of the nozzle body 41, it is possible to maintain the thermal spray powder 36A to 36C having different particle diameters inside the plasma flame 37 or in the vicinity of the plasma flame 37 with the fluid supplied from the radially outer side of the nozzle body 41 to sufficiently heat and melt the thermal spray powder.

Accordingly, rates at which the thermal spray powder 36A to 36C supplied from the powder introduction port 43 is heated and melted can be sufficiently enhanced.

Additionally, the plasma thermal spray device 10 including the above thermal spray nozzle 14 can obtain the same effect as the effect of the above-described thermal spray nozzle 14.

In addition, in the first embodiment, as an example, the powder introduction port 43, which is disposed above the main flow passage 48 and through which the thermal spray powder 36 is sprayed in the direction (Z direction) perpendicular to the plasma flame 37, has been described as an example. However, the powder introduction port 43 may be a portion of the nozzle body 41 located downstream of the upstream end 41A and may be at a position where the thermal spray powder 36 is capable of being supplied from the radially outer side of the nozzle body 41 to the plasma flame 37, the formation position of the powder introduction port 43 is not limited to the formation position illustrated in FIG. 1.

Additionally, the direction in which the thermal spray powder 36 is sprayed may be the direction (the radial direction of the plasma flame 37) perpendicular to the plasma flame 37 and is not limited to the Z direction. For example, the thermal spray powder 36 may be sprayed from a lateral direction with respect to the plasma flame 37, or the thermal spray powder 36 may be sprayed from below the plasma flame 37.

Additionally, in the first embodiment, as an example, a case where the thermal spray powder 36 is supplied from one powder introduction port 43 has been described as an example. However, a plurality of the powder introduction ports 43 may be provided.

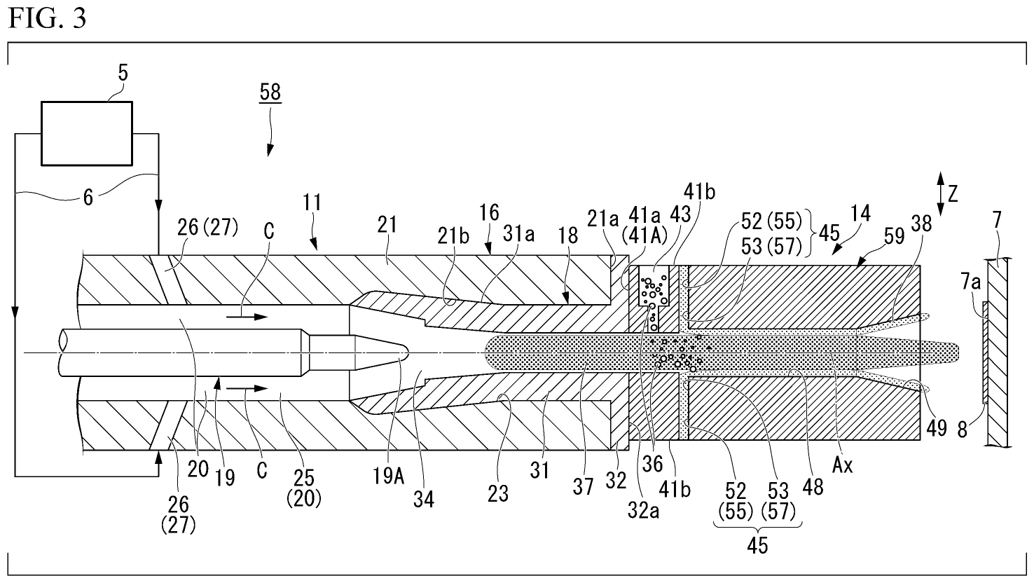

Here, a plasma thermal spray device 58 according to a first modification example of the first embodiment of the invention will be described with reference to FIG. 3.

The plasma thermal spray device 58 is configured similarly to the plasma thermal spray device 10 except for having a nozzle body 59 instead of the nozzle body 41 that constitutes the plasma thermal spray device 10 of the first embodiment.

The nozzle body 59 is configured similarly to the nozzle body 41 except that the internal diameter of the main flow passage 48 formed downstream of the fluid introduction port 45 is made to be larger than the internal diameter of the main flow passage 48 formed upstream of the fluid introduction port 45.

In the plasma thermal spray device 58 having the nozzle body 59 having such a configuration, the amount of suction of the fluid (for example, air) from the fluid introduction port 45 increases. Therefore, the thermal spray powder 36 can be more easily maintained within the plasma flame 37 than the nozzle body 41.

Additionally, the cooling effect of the nozzle body 59 by the low-temperature fluid 38 can be enhanced.

Additionally, the thermal influence exerted on the nozzle body 59 from the plasma flame 37 can be alleviated by the low-temperature fluid 38.

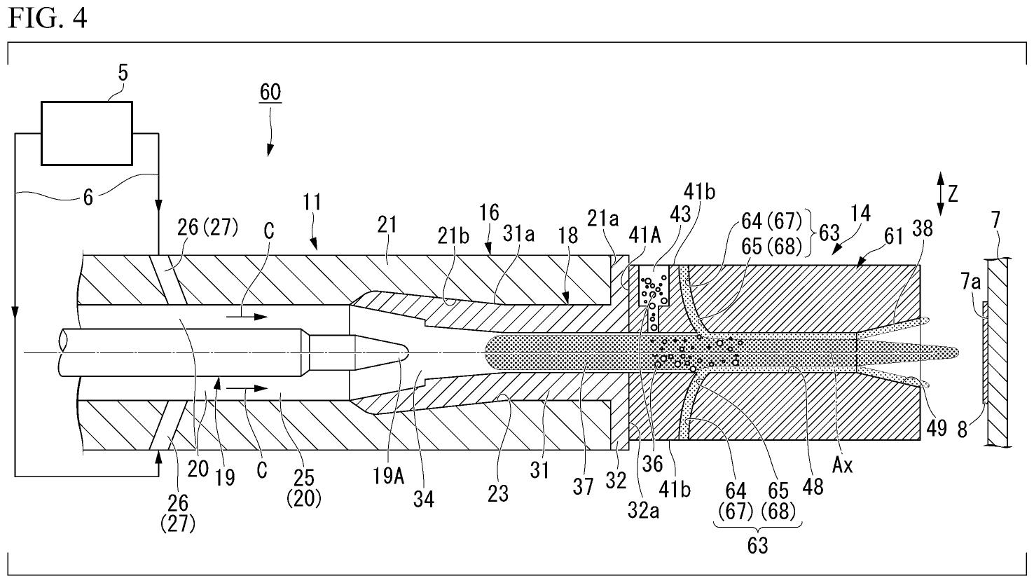

Here, a plasma thermal spray device 60 according to a second modification example of the first embodiment will be described with reference to FIG. 4. In FIG. 4, the same components as those of the structural body illustrated in FIGS. 1 and 2 will be designated by the same reference signs.

The plasma thermal spray device 60 is configured similarly to the plasma thermal spray device 10 except for having a thermal spray nozzle 61 instead of the thermal spray nozzle 14 that constitutes the plasma thermal spray device 10 of the first embodiment.

The thermal spray nozzle 61 is configured similarly to the thermal spray nozzle 14 except for having a fluid introduction port 63 instead of the fluid introduction port 45 that constitutes the thermal spray nozzle 14.

The fluid introduction port 63 has a first introduction port part 64 and a second introduction port part 65. The first introduction port part 64 is provided at an outer peripheral part of the nozzle body 41.

The first introduction port part 64 is constituted of a plurality of introduction holes 67 that is inclined in a direction toward the downstream side of the main flow passage 48 from the upstream end 41A of the main flow passage 48. The plurality of introduction holes 67 are radially formed about the axis Ax. One end of each of the plurality of introduction holes 67 is exposed from the outer surface 41b of the nozzle body 41.

The plurality of introduction holes 67 has a configuration in which the plurality of introduction holes 55 described in the first embodiment is inclined (also including curving).

The second introduction port part 65 is configured of a ring-shaped introduction groove 68 that is inclined in the direction toward the downstream side of the main flow passage 48 from the upstream end 41A of the main flow passage 48 (also including curving). The introduction groove 68 communicates with the plurality of introduction holes 67 and the main flow passage 48.

According to the plasma thermal spray device 60 according to the second modification example of a first embodiment, by including the fluid introduction port 63 that is inclined in the direction toward the downstream side of the main flow passage 48 (also including curving) from the upstream end 41A of the main flow passage 48, it is difficult that the fluid flowing into the main flow passage 48 via the fluid introduction port 63 collides with the plasma flame 37. Therefore, the plasma flame 37 can be stabilized.

### Second Embodiment

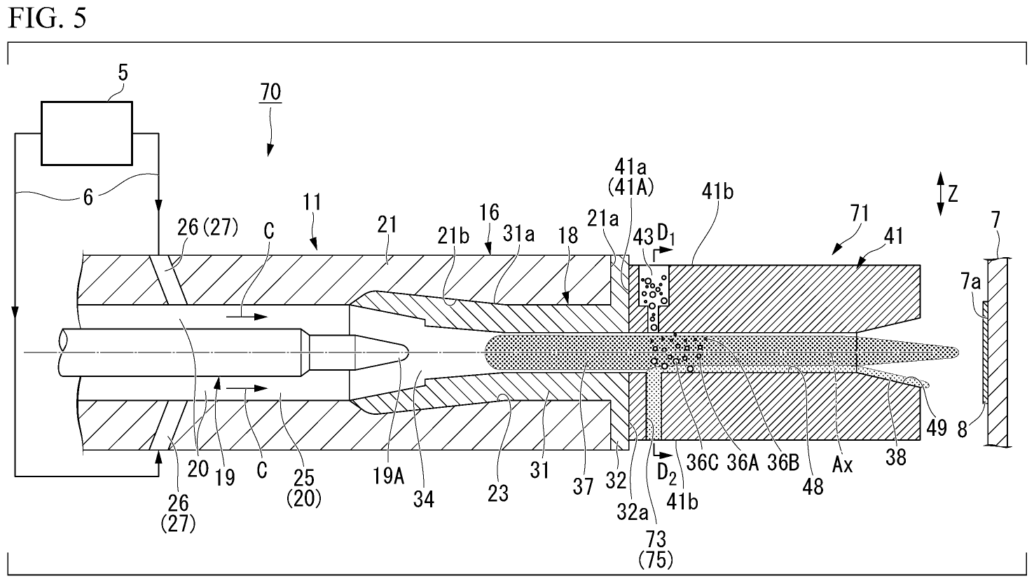

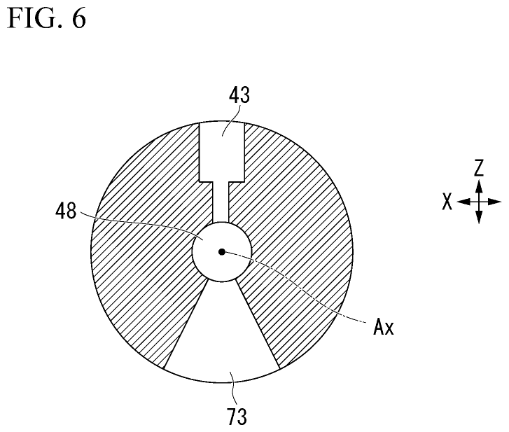

A plasma thermal spray device 70 according to a second embodiment of the invention will be described with reference to FIGS. 5 and 6. In FIG. 5, the same components as those of the structural body illustrated in FIG. 1 will be designated by the same reference signs.

In FIG. 6, illustration of the plasma flame 37 illustrated in FIG. 5 and the thermal spray powder 36A to 36C is omitted. An X direction illustrated in FIG. 6 indicates a direction orthogonal to the Z direction and the axis Ax. In FIG. 6, the same components as those of the structural body illustrated in FIG. 5 will be designated by the same reference signs.

The plasma thermal spray device 70 is configured similarly to the plasma thermal spray device 10 except for having a thermal spray nozzle 71 instead of the thermal spray nozzle 14 that constitutes the plasma thermal spray device 10 of the first embodiment.

The thermal spray nozzle 71 is configured similarly to the thermal spray nozzle 14 except for having a fluid introduction port 73 instead of the fluid introduction port 45 that constitutes the thermal spray nozzle 14 of the first embodiment.

The fluid introduction port 73 is provided in the nozzle body 41 that is located at the same axial position as the powder introduction port 43 and below the powder introduction port 43. The fluid introduction port 73 is constituted of an introduction groove 75 of which the width in the X direction becomes narrower toward the axis Ax from the outer surface 41b of the nozzle body 41 as seen in the axis direction.

In this way, by including the introduction groove 75 that becomes narrower toward the main flow passage 48 from the outer surface 41b of the nozzle body 41 as seen in the axis direction, it is possible to increase the flow velocity of the fluid flowing into the main flow passage 48 from the introduction groove 75.

Accordingly, it is possible to maintain the thermal spray powder 36C having a larger particle diameter inside the plasma flame 37 or in the vicinity of the plasma flame 37 using the fluid that flows into the main flow passage 48 from the introduction groove 75. Thus, the thermal spray powder 36C can be heated and melted.

According to the plasma thermal spray device 70 of the second embodiment, by including the fluid introduction port 73 provided in the nozzle body 41 that is located at the same axial position as the powder introduction port 43 and below the powder introduction port 43, the thermal spray powder 36C (thermal spray powder having a large momentum (initial momentum) when being sprayed from the powder introduction port) having a larger particle diameter can be maintained inside the plasma flame or in the vicinity of the plasma flame and can be heated and melted.

That is, the rate at which the thermal spray powder 36A to 36C supplied from the powder introduction port 43 is heated and melted can be enhanced.

In addition, in a second embodiment, a case where one fluid introduction port 73 is provided only below the powder introduction port 43 has been described as an example. However, a plurality of the fluid introduction ports 73 may be provided at the same axial position as the powder introduction port 43.

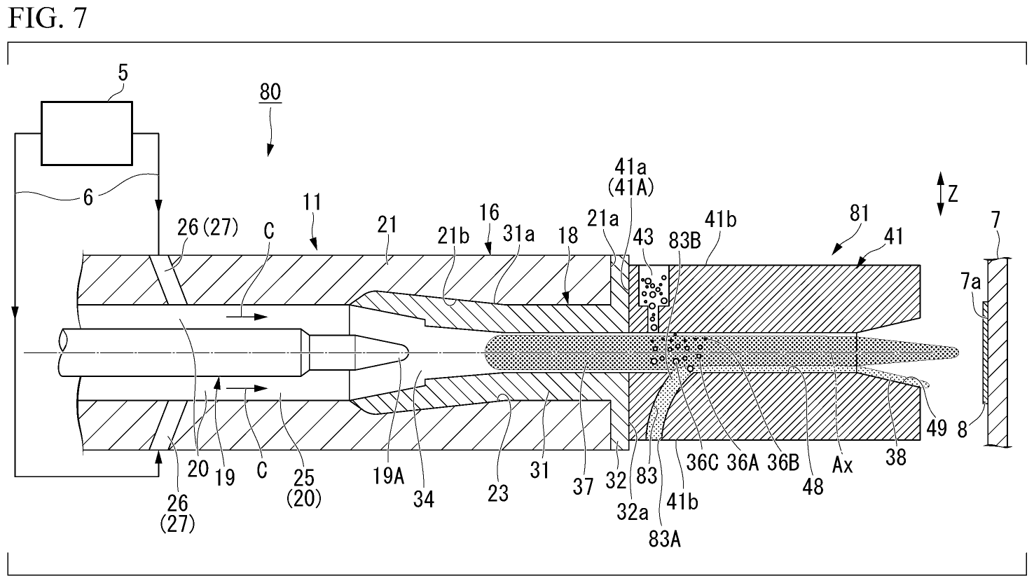

Next, a plasma thermal spray device 80 according to a modification example of the second embodiment will be described with reference to FIG. 7. In FIG. 6, the same components as those of the structural body illustrated in FIGS. 5 and 6 will be designated by the same reference signs.

The plasma thermal spray device 80 is configured similarly to the plasma thermal spray device 70 except for having a thermal spray nozzle 81 instead of the thermal spray nozzle 71 that constitutes the plasma thermal spray device 70 of the second embodiment.

The thermal spray nozzle 81 has the same configuration as the thermal spray nozzle 71 except for having a fluid introduction port 83 instead of the fluid introduction port 73 that constitutes the thermal spray nozzle 71.

The fluid introduction port 83 has the shape in which the introduction groove 75 described in the third embodiment is curved toward the injection port 49.

The fluid introduction port 83 has an inlet opening 83A into which the fluid is introduced, and an outlet opening 83B through which the fluid is delivered to the main flow passage 48.

The inlet opening 83A is disposed at the same axial position as the powder introduction port 43 and below the powder introduction port 43.

The outlet opening 83B is provided in the nozzle body 41 located downstream than a formation position of the inlet opening 83A.

According to the plasma thermal spray device 80 according to the modification example of the second embodiment, by disposing the outlet opening 83B of the fluid introduction port 83 downstream of the formation position of the inlet opening 83A, the fluid to be delivered from the outlet opening 83B of the fluid introduction port 83 does not easily collide with the plasma flame 37. Therefore, the plasma flame 37 can be stably formed.

In addition, in the modification example of the second embodiment, a case where one fluid introduction port 83 is provided only below the powder introduction port 43 has been described as an example. However, a plurality of the fluid introduction ports 83 may be provided at the same axial position as the powder introduction port 43.

Although the preferred embodiments for carrying out the invention have been described above in detail, the invention is not limited to the relevant specific embodiments, and various alterations and changes can be made within the scope of the invention described in the claims.

### INDUSTRIAL APPLICABILITY

The invention is applicable to a thermal spray nozzle and a plasma thermal spray device.

### REFERENCE SIGNS LIST

5: gas supply source
6: gas supply line
7: object to be treated
7a: film formation surface
8: thermal spray film
10, 58, 60, 70, 80: plasma thermal spray device
11: plasma generation mechanism
14, 61, 71, 81: thermal spray nozzle
16: electrode housing part
18: anode electrode
19: cathode electrode
19A: distal end
20: second flow passage
21: electrode housing part body
21a: end surface
21b: inner peripheral surface
23: cathode-electrode housing part
25: anode-electrode housing part
26: gas introduction part
27: gas introduction hole
31: electrode body part
31a: outer peripheral surface
32: flange part
34: first flow passage
36, 36A, 36B, 36C: thermal spray powder
37: plasma flame
38: low-temperature fluid
41a: surface
41A: upstream end
41b: outer surface
41, 59: nozzle body
43: powder introduction port
45, 63, 73, 83: fluid introduction port
48: main flow passage
49: injection port
52, 64: first introduction port part
53, 65: second introduction port part
55, 67: introduction hole
57, 68, 75: introduction groove
83A: inlet opening
83B: outlet opening
C direction

1. A thermal spray nozzle comprising:
a nozzle body having a main flow passage that has a plasma flame formed therein in a direction toward a downstream side from an upstream end disposed on one side in an axis direction, and extending along an axis;
a powder introduction port that is disposed in a portion of the nozzle body located the downstream side from the upstream end and introduces thermal spray powder from a radially outer side of the nozzle body to the plasma flame; and
a fluid introduction port that is disposed at a position closer to the downstream side than a formation position of the powder introduction port in the nozzle body or at a same position in the axis direction as the powder introduction port in the nozzle body, and introduces working fluid into the main flow passage from the radially outer side of the nozzle body,
wherein the working fluid is air, and
wherein an outer surface of the nozzle body that exposes one end of the fluid introduction port is exposed to the air at atmospheric pressure.

2. The thermal spray nozzle according to claim 1, wherein an opening diameter of the fluid introduction port is a size such that the working fluid present outside the fluid introduction port is allowed to be suctioned into the main flow passage via the fluid introduction port.

3. The thermal spray nozzle according to claim 1, wherein the thermal spray powder has a particle size distribution.

4. (canceled)

5. The thermal spray nozzle according to claim 1,
wherein the fluid introduction port is disposed at a position closer to the downstream side than the formation position of the powder introduction port, and
wherein the fluid introduction port is disposed to be orthogonal to the main flow passage.

6. The thermal spray nozzle according to claim 1,
wherein the fluid introduction port is disposed at a position closer to the downstream side than the formation position of the powder introduction port, and
wherein the fluid introduction port is disposed to be inclined in a direction toward the downstream side of the main flow passage from the upstream end of the main flow passage.

7. The thermal spray nozzle according to claim 1,
wherein the fluid introduction port has:
a first introduction port part that is provided at an outer peripheral part of the nozzle body, and
a second introduction port part that is provided inside the outer peripheral part of the nozzle body and communicates with the first introduction port part and the main flow passage,
wherein the first introduction port part includes a plurality of introduction holes that extend radially about the axis, and
wherein the second introduction port part is an introduction groove having a ring shape that surrounds the main flow passage from a circumferential direction.

8. The thermal spray nozzle according to claim 1,
wherein the fluid introduction port is an introduction groove disposed at a same position in the axis direction as the powder introduction port and below the powder introduction port, and
wherein the introduction groove guides the working fluid in a direction orthogonal to the main flow passage.

9. The thermal spray nozzle according to claim 1,
wherein the fluid introduction port has:
an inlet opening that is disposed at an outer surface side of the nozzle body and allows the working fluid to be introduced thereinto, and
an outlet opening that allows the working fluid to be delivered to the main flow passage therethrough,
wherein the introduction port is disposed at a same position in the axial direction as the powder introduction port, and
wherein the outlet opening is disposed at a position closer to the downstream side than a formation position of the introduction port.

10. The thermal spray nozzle according to claim 8, wherein the introduction groove becomes narrower toward the axis from an outer peripheral surface of the nozzle body when viewed from the axis direction.

11. The thermal spray nozzle according to claim 1, wherein the powder introduction port is disposed above the main flow passage, and sprays the thermal spray powder to the plasma flame formed in the main flow passage from a vertical direction.

12. The thermal spray nozzle according to claim 1, further comprising:
an injection port that is provided the other side in the axis direction of the nozzle body, communicates with the main flow passage, and allows the melted thermal spray powder to be sprayed therethrough.

13. The thermal spray nozzle according to claim 12, wherein an internal diameter of the injection port increases toward the other side of the nozzle body in the axis direction from the one side of the nozzle body in the axis direction.

14. A plasma thermal spray device comprising:
the thermal spray nozzle according to claim 1;
a cathode electrode that is disposed at an upstream end side of the nozzle body and has a first flow passage communicating with the main flow passage;
an anode electrode that is disposed at a position closer to the downstream side than the cathode electrode and causes discharge in the first flow passage together with the cathode electrode; and
an electrode housing part that houses the cathode electrode and the anode electrode, and has a second flow passage formed between the anode electrode and the electrode housing part and communicating with the first flow passage, and a gas introduction part introducing a gas for forming a plasma flame in the second flow passage.
